(19) United States
(12) Patent Application Publication
(10) Pub. No.: US 2005/0090143 A1
(43) Pub. Date: Apr. 28, 2005

(54) Thread-connected RCA connector

(76) Inventor: Pony Guo, Taipei (TW)

Correspondence Address: PONY GUO, 235 CHUNG-HO BOX 8-24, TAIPEI HSIEN, 235, TW

(21) Appl. No.: 10/694,605

(22) Filed: Oct. 24, 2003

(51) Int. Cl. H01R 11/00

(52) U.S. Cl. 439/502

(57) ABSTRACT

A thread-connected RCA connector comprises a connector and a cover. One end of the connector is threaded and is screwed to a video coaxial cable; and another end of the connector has a protruded annular wall. A center of the annular wall is protruded with a metal lead. A signal wire is connected to the metal lead. One end the signal wire passes through one through hole of the annular wall and another end of the signal wire is connected to a built-in video card; and a cover covers the annular wall. A lateral side of the cover has an opening so that the signal wire passes through the opening.

### FIELD OF THE INVENTION

The present invention relates to connectors, and particular to a thread-connected RCA connector which is used to the signal processing of electronic, communicational and electric devices, such as notebook computers, bluetooth products, desk-top computers, etc for reducing electromagnetic interference so as to has a preferred signal quality.

### BACKGROUND OF THE INVENTION

With the improvement of technology, current notebook computers have function of inputting video signals. The notebook computer is capable of being connected with a video coaxial cable for viewing video, programs. Furthermore, bluetooth wireless communication products need coaxial cables for transmitting signals. FIG. 1 shows a prior art RCA connector. A lower end of the RCA connector has a threaded end 11 and a top thereof is protruded with a metal lead 12 which is further connected to one end of a signal wire 13. Another end of the signal wire 13 is connected to a built-in video interface in a notebook computer 14 (of other products).

However, the prior art RCA connector has a defect that the connection of the metal lead 12 and the signal wire 13 are exposed out. Although welding tin encloses them, no shielding is used. Furthermore, a periphery of the metal lead 12 is not shielded so that a larger part of the metal lead 12 exposes out. Thus electromagnetic interference cannot be avoided. Thus, signals, are easily interfered by electromagnetic waves from other electronic elements on the circuit board so as to affect the quality of signals.

### SUMMARY OF THE INVENTION

Accordingly, the primary object of the present invention is to provide a thread-connected RCA connector, wherein the electromagnetic interference can be reduced effectively so as to have preferred video quality. Further, the present invention can be made easily and the decay of the video signals is reduced.

To achieve above object, the present invention provided a thread-connected RCA connector which comprises a connector and a cover. One end of the connector is threaded and is screwed to a video coaxial cable; and another end of the connector has a protruded annular wall. A center of the annular wall is protruded with a metal lead. A signal wire is connected to the metal lead. One end the signal wire passes through one through hole of the annular wall and another end of the signal wire is connected to a built-in video card; and a cover covers the annular wall. A lateral side of the covet has an opening so that the signal wire passes through the opening.

Moreover, a height of the metal lead is higher than that of the annular wall. The threaded end of the connector is fixed to a through hole of a device casing by using at least one tightening threaded rings. A stop ring spaces the threaded end of the connector and the annular wall. An outer diameter of the stop ring is larger than those of the connector and the annular wall.

The various objects and advantages of the present invention will be more readily understood from the following detailed description when read in conjunction with the appended drawing.

### BRIEF DESCRIPTION OF THE DRAWINGS

FIG. 1 is a schematic perspective view of the prior art RCA connector.

FIG. 2 is an exploded perspective view of the RCA connector of the present invention.

FIG. 3 is an assembled perspective view of the RCA connector of the present invention.

FIG. 4 is a schematic view showing the application of the present invention.

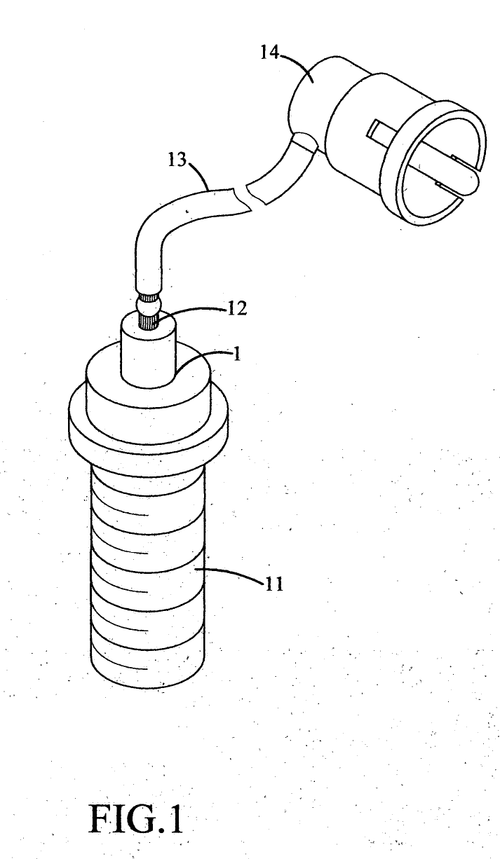

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

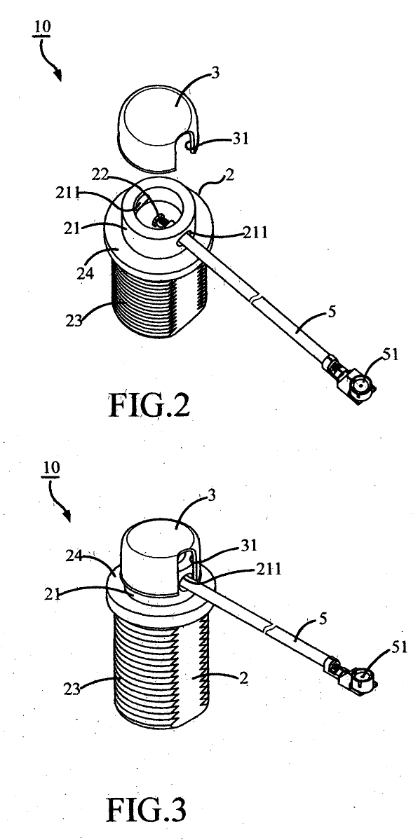

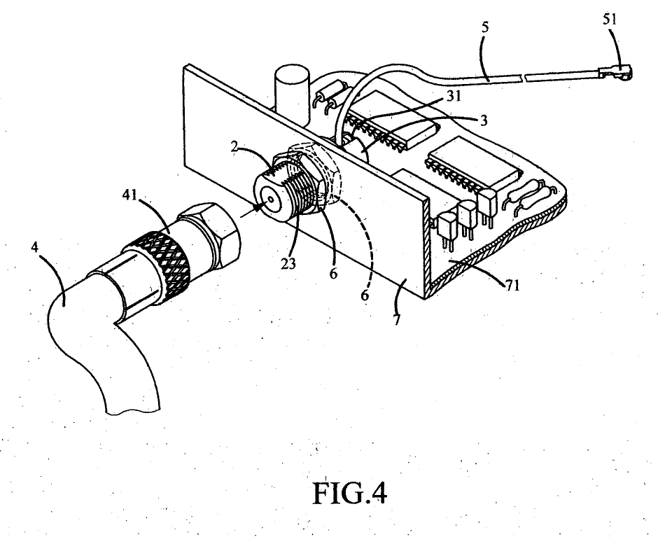

Referring to FIG. 2 the embodiment of the, present invention will be described herein. An exploded perspective view of an, RCA connector is. illustrated. The RCA connector 10 includes a connector 2 and a cover 3. An assembled perspective view is illustrated in FIG. 3. A center of one end of the connector 2 has a metal lead 22. A periphery of the metal lead 22 is enclosed by an annular wall 21. The annular wall 21 has through holes 211. A signal wire 5 connected to the metal lead 22 is lead out from the through holes 211. In this embodiment, two through holes 211 are arranged oppositely and symmetrically so that the signal wire 5 selectively passes through one of the through holes 211. Moreover, a height of the annular wall 21 must higher than the metal lead 22 so as, to reduce electromagnetic interference. Next, another end of the connector 2 has threads, 23. The thread 23 and the annular wall 21 are spaced by a protruded stop ring 24 with has a larger diameter. The thread 23 serves to connect a coaxial cable and can be used with a tightening threaded ring 6 for being fixed to a predetermined position of a casing.

Furthermore, the cover 3 covers the annular wall 21 for tightly sealing the annular wall 21. An opening of the cover 3 is aligned to one through hole 211 of the annular wall 21 so that the signal wire 5 can pass through the through hole 211. The signal wire 5 is a soft wire (for example, 75 Ohm wire). Thereby, the signal wire 5 can be bent to suit a space receiving the wire and thus it can be easily connected to an interface card. Besides, the cover 3 seals the annular wall 21 for preventing electromagnetic interference.

An embodiment of the present invention illustrated in FIG. 4. It is shown that the thread 23 of the connector 2 is screwed to a lateral wall of a notebook casing 7 by two tightening threaded rings 6 and then the thread 23 passes through the wall of the notebook casing 7 to be connected to a joint 41 of a coaxial cable 41. Another end of the signal wire 5 is connected to a video interface (not shown) to be combined to the interface. The bared wire connected to the metal lead 22 is enclosed by the annular wall 21 arid shielded by the cover 3 so as to prevent the electromagnetic interference so as to reduce the lose of video signals. Thus the video signals have preferred quality.

Advantages of the present invention is that the electromagnetic interference can be reduced effectively so as to have preferred video quality. Further, the present invention can be made easily and the decay of the video signals is reduced.

The present invention is thus described, it will be obvious that the same may be varied in many ways. Such variations are not to be, regarded as a departure from the spirit and scope of the present invention, and all such modifications as would be obvious to one skilled in the art are intended to be included within the scope of the following claims.

1. A thread-connected RCA connector having a connector and a cover; wherein
one end of the connector is threaded and is screwed to a video coaxial cable; and another end of the connector has a protruded annular wall, a center of the annular wall is protruded with a metal lead; a signal wire is connected to the metal lead; one end the signal wire passes through one through hole of the annular wall and another end of the signal wire is connected to a built-in video card; and a cover covers the annular wall; a lateral side of the cover has an opening so that the signal wire passes through the opening.

2. The thread-connected RCA connector as claimed in claim 1, wherein a height of the metal lead is higher than that of the annular wall.

3. The thread-connected RCA connector as claimed in claim 1, wherein the threaded end of the connector is fixed to a through hole of a device casing by using at least one tightening threaded rings.

4. The thread-connected RCA connector as claimed in claim 1, wherein a stop ring spaces the threaded end of the connector and the annular wall, and an outer diameter of the stop ring is larger than those of the connector and the annular wall.
